(19) United States
(12) Patent Application Publication
(10) Pub. No.: US 2015/0054279 A1
(43) Pub. Date: Feb. 26, 2015

(54) SYSTEM FOR A HYDRAULICALLY POWERED ELECTRIC GENERATOR

(71) Applicant: SAUER-DANFOSS INC., AMES, IA (US)

(72) Inventors: Douglas P. Anderson, Nevada, IA (US); Michael J. Stoltenow, Greenfield, MN (US)

(73) Assignee: SAUER-DANFOSS INC., AMES, IA (US)

(21) Appl. No.: 13/973,359

(22) Filed: Aug. 22, 2013

(51) Int. Cl. F03B 13/00

(52) U.S. Cl. CPC F03B 13/00
USPC 290/43

(57) ABSTRACT

A system for a hydraulically powered electric generator having a hydraulic motor coupled to an electric generator. The electric generator has a field coil that provides field excitation in the rotor. The rotor also has a permanent magnet that provides initial field excitation. A voltage regulator is connected to the rotor to adjust current in the field coil to maintain a constant output voltage as generator speed and load varies.

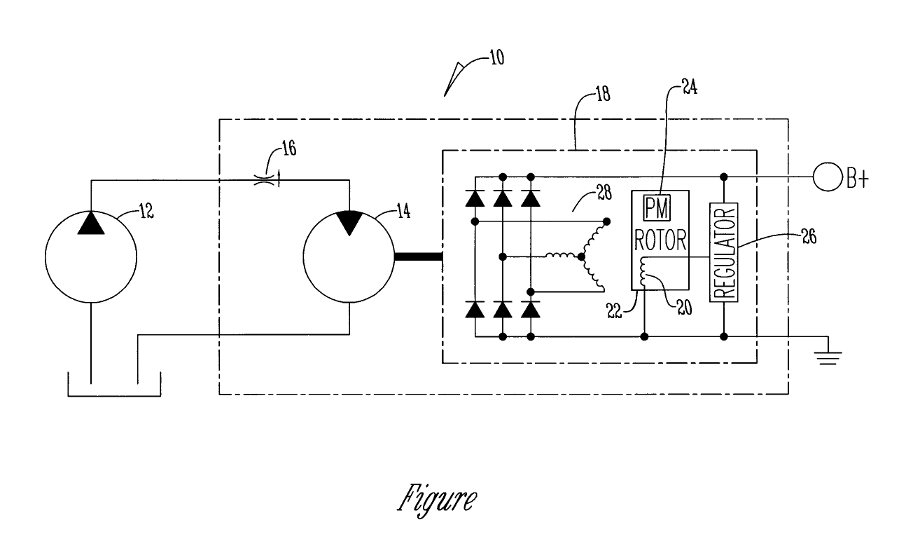

### BACKGROUND OF THE INVENTION

This invention is directed to a hydraulically powered generator and more particularly a hydraulically powered generator that produces a constant output voltage as the generator speed and loads vary.

Combining hydraulic motors with electric generators is known in the art. One problem that exists with current systems is that a battery or other source of electrical start-up current is needed. In a number of applications the use of electrical power is expensive, inconvenient, or prohibited by government regulation to route the electric power to a location on the machine. In addition, these systems adjust the speed of the hydraulic motor to regulate the output voltage. Therefore, a need exists in the art for a system that addresses these needs and deficiencies.

An objective of the present invention is to provide a system that generates start-up current without the use of a battery or other source of electrical start-up current.

Another objective of the present invention is to provide a system that generates a constant output voltage as generator speed and load varies.

A still further objective of the present invention is to provide a system where the speed of a hydraulic motor is stabilized within an acceptable range.

These and other objectives will be apparent to one of ordinary skill in the art based upon the following written description, drawings and claims.

### SUMMARY OF THE INVENTION

A system for a hydraulically powered electric generator having a hydraulic motor coupled to an electric generator. The electric generator has a field coil that provides field excitation current in a motor. The rotor also has a permanent magnet that provides initial field excitation current. A voltage regulator is connected to the rotor to adjust current in the field coil to maintain a constant output voltage as generator speed and load varies.

### BRIEF DESCRIPTION OF THE FIGURE

The FIGURE is a schematic view of a hydraulically powered electric generator.

### DETAILED DESCRIPTION OF THE PREFERRED EMBODIMENTS

Referring to the FIGURE, a system 10 for a hydraulically powered electrical generator includes a hydraulic pump 12 connected to, and in fluid communication with, a hydraulic motor 14. In one embodiment, a hydraulic flow control valve 16 is connected in-line between the hydraulic pump 12 and the hydraulic motor 14 to stabilize the speed of the hydraulic motor 14 within an acceptable range if the source of hydraulic fluid flow is not already stabilized such as with a fixed displacement pump without other hydraulic loads.

Coupled to the hydraulic motor 14 is a brushed rotating field (BFR) generator 18 with a field coil 20 that provides field excitation current in a rotor 22. A permanent magnet 24 is disposed within the rotor 22 which provides initial field excitation current to start the generator process which eliminates the need for a battery or alternative source of start-up current.

The generator 18 has an electronic controller or voltage regulator 26 connected to the rotor 22 to adjust the current in the field coil 20 to maintain a constant output voltage as the generator 18 speed and load vary. In one embodiment the generator has one or more rectifiers 28 to convert AC output to DC output.

In operation, fluid is supplied to the hydraulic motor 14 at an acceptable flow rate from the hydraulic pump 12. The permanent magnet 24 in the rotor 22 provides initial field excitation current to start the generation process and produce an output voltage. As the generator 18 speed or load varies, the voltage regulator 26 adjusts the current in the field coil 20 to maintain a constant output voltage.

Therefore, a system for a hydraulically powered electric generator has been disclosed that produces a constant output voltage and, at the very least, meets all the stated objectives.

What is claimed is:

1. A system for a hydraulically powered electric generator, comprising:
a hydraulic pump in fluid communication with a hydraulic motor;
a brushed rotating field generator having a field coil that provides field excitation in a rotor wherein the generator is coupled to the hydraulic motor;
a permanent magnet disposed within the rotor; and
a voltage regulator attached to the rotor to adjust current in the field coil to maintain a constant output voltage as the generator speed and load vary.

2. The system of claim 1 wherein the generator has at least one rectifier.

3. The system of claim 1 wherein the pump is a variable speed displacement pump and a hydraulic flow control valve is connected in-line between the pump and the motor.
